(19) United States
(12) Patent Application Publication
(10) Pub. No.: US 2016/0232492 A1
(43) Pub. Date: Aug. 11, 2016

(54) FLEXIBLE WORKFLOW AUTOMATION SYSTEM

(71) Applicant: MAX NALSKY, Moscow (RU)

(72) Inventor: MAX NALSKY, Moscow (RU)

(21) Appl. No.: 14/797,362

(22) Filed: Jul. 13, 2015

Related U.S. Application Data
(63) Continuation-in-part of application No. 14/617,867, filed on Feb. 9, 2015.

(51) Int. Cl. G06Q 10/10; G06F 17/24; G06F 3/0484; G06F 3/0482

(52) U.S. Cl. CPC G06Q 10/103; G06F 3/0482; G06F 17/24; G06F 3/0484

(57) ABSTRACT

A computerized workflow automation system comprising: at least one workflow automation server accessible via a computer network, the workflow automation server comprising: an application engine executing one or more workflows comprising a plurality of ordered workflow steps; and a user interface portion configured to provide each user with a single actionable inbox comprising a plurality of items, the plurality of items corresponding to the plurality of ordered workflow steps of the workflow; and a workflow automation client configured to access the workflow automation server via the computer network.

### CROSS-REFERENCE TO RELATED PATENT APPLICATION

This U.S. patent application relies upon, claims the benefit of priority from and is a continuation-in-part of a co-pending U.S. patent application Ser. No. 14/617,867 filed on Feb. 9, 2015, which is incorporated by reference herein in its entirety.

### BACKGROUND OF THE INVENTION

1. Technical Field

The disclosed embodiments relate in general to technology for productivity management and, more specifically, to systems and methods for implementing a flexible workflow automation system.

2. Description of the Related Art

Modern enterprise uses a variety of software systems for different organizational functions and processes, such as human resources, procurement, marketing, sales, production, inventory, accounting, information technology, and the like. On the other hand, when people need to coordinate, they use email. Email is the only communication software that is used by everyone in the enterprise. While various departments within an enterprise may have various other collaboration tools available, email remains the lowest common denominator for everybody.

On the other hand, email has numerous well-known flaws, as it is: overloaded, in-actionable, maybe confusing, not integrated sufficiently deep into other functional software, incapable of providing any shared structure (it contains only personal folders).

Therefore, in view of the aforesaid deficiencies with the conventional collaboration tools, new and improved systems and methods are needed to improve coordination, eliminate corporate friction, and help people get things done.

### SUMMARY OF THE INVENTION

The embodiments described herein are directed to methods and systems that substantially obviate one or more of the above and other problems associated with conventional systems and methods for workflow automation.

In accordance with one aspect of the embodiments described herein, there is provided a computerized workflow automation system comprising: at least one workflow automation server accessible via a computer network, the workflow automation server comprising: an application engine executing one or more workflows comprising a plurality of ordered workflow steps; and a user interface portion configured to provide each user with a single actionable inbox comprising a plurality of items, the plurality of items corresponding to the plurality of ordered workflow steps of the workflow. The computerized workflow automation system further comprises a workflow automation client configured to access the workflow automation server via the computer network.

In one or more embodiments, the user interface portion is further configured to provide a workflow input form comprising a plurality of input fields corresponding to the plurality of ordered workflow steps of a workflow.

In one or more embodiments, the plurality of input fields are individual fields, groups of fields, or line item table fields.

In one or more embodiments, a field of the plurality of input fields is automatically calculated from values of other fields of the plurality of input fields.

In one or more embodiments, a field of the plurality of input fields is associated with a pull action such that a value of the field is automatically filled out by a query issued to an external system.

In one or more embodiments, the workflow input form is automatically filled in by an external application.

In one or more embodiments, the workflow input form is associated with a plurality of printed layouts.

In one or more embodiments, the system automatically assigns at least one participant to one or more of the plurality of ordered workflow steps pursuant to one or more rules and depending on values of the workflow input form.

In one or more embodiments, the rules comprise logical, mathematical, text manipulation or other operations.

In one or more embodiments, the system further comprises a notification service configured to execute a communication thread to receive and handle comments from users and log actions associated with the workflow.

In one or more embodiments, each step of the workflow is associated with one user or a plurality of users.

In one or more embodiments, some steps of the workflow are associated with one or more user roles.

In one or more embodiments, a step of the workflow is associated with at least two users or a plurality of users and at least two user roles.

In one or more embodiments, the user interface portion is further configured to enable the user to approve one of the plurality of items from the actionable inbox of the user and wherein upon the approval by the user, the respective item is removed from the actionable inbox of the user.

In one or more embodiments, the user interface portion is further configured to enable the user to change one or more values of the workflow input form, causing to automatic recalculation of participants of one or more of the plurality of ordered workflow steps.

In one or more embodiments, the automatic recalculation is performed with respect to future workflow steps.

In one or more embodiments, the automatic recalculation is performed with respect to past workflow steps.

In one or more embodiments, the user interface portion is further configured to enable the user to add a comment to the workflow.

In one or more embodiments, the user interface portion is further configured to enable the user to perform an action with respect to one of the plurality of items from the actionable inbox of the user and wherein upon performance of the action by the user, the respective item is removed from the actionable inbox of the user.

In one or more embodiments, the user action comprises an action performed in an external system or causes a message to be sent.

In one or more embodiments, upon every user or user role associated with a step of the workflow performing an action with respect to that step of the workflow, the workflow is configured to proceed to a subsequent step.

In one or more embodiments, a step of the workflow is assigned an attribute indicative of a status of completion of that step.

In one or more embodiments, the attribute is selected from a group comprising: opened, confirmed, in progress, in testing, verified, completed and one or more custom attributes specified by the administrator.

In one or more embodiments, the user interface portion is further configured to enable the user to organize the actionable inbox into one or more subfolders.

In one or more embodiments, the workflow automation client is web-based.

In one or more embodiments, the workflow automation client is a mobile application based.

In one or more embodiments, the workflow automation client is a desktop application based.

In one or more embodiments, the workflow automation client is a smartwatch application based.

In one or more embodiments, the notification service is configured to provide push notifications or desktop notifications to a workflow automation client of a user, when an action of that user is required with respect to a step of the workflow.

In one or more embodiments, the computerized workflow automation system comprises at least two workflow automation servers configured as a server cluster.

In one or more embodiments, the application engine executes a plurality of different workflows, each of the plurality of different workflows being associated with at least one administrator who has been designated to configure the each workflow.

In one or more embodiments, different workflows are assigned to different administrators.

In one or more embodiments, the computerized workflow automation system further comprises a notification service configured to generate email notification to indicate that an action is required from a user associated with the workflow.

In one or more embodiments, the computerized workflow automation system further comprises a notification service configured to generate email notification to indicate that a plurality of actions is required from a user associated with the workflow.

In one or more embodiments, the computerized workflow automation system further comprises a reporting engine configured to provide summary reports comprising a total number of tasks, daily opened/closed steps, time to complete the workflow, or predetermined steps of the workflow, breakdown of quantitative metrics by user, workflow step or a predetermined form field.

In one or more embodiments, the time to complete the workflow is based on working hours schedule.

In one or more embodiments, the reports are filtered based on predetermined parameters.

In one or more embodiments, the reports are printed.

In one or more embodiments, the reports are exported to an external document or automatically electronically transmitted to one or more recipients.

In accordance with another aspect of the embodiments described herein, there is provided a computer-implemented workflow automation method comprising: providing a workflow automation server accessible via a computer network, the workflow automation server comprising: an application engine executing one or more workflows comprising a plurality of ordered workflow steps; and a user interface portion configured to provide each user with a single actionable inbox comprising a plurality of items, the plurality of items corresponding to the plurality of ordered workflow steps of the workflow; and providing a workflow automation client configured to access the workflow automation server via the computer network.

In one or more embodiments, the user interface portion is further configured to provide a workflow input form comprising a plurality of input fields corresponding to the plurality of ordered workflow steps of a workflow.

In one or more embodiments, the computer-implemented workflow automation method further comprises providing a notification service configured to execute a communication thread to receive and handle comments from users and log actions associated with the workflow.

In one or more embodiments, each step of the workflow is associated with one user or a plurality of users.

In one or more embodiments, some steps of the workflow are associated with one user, a plurality of users, or a plurality of user roles.

In one or more embodiments, the user interface portion is further configured to enable the user to approve one of the plurality of items from the actionable inbox of the user and wherein upon the approval by the user, the respective item is removed from the actionable inbox of the user.

In one or more embodiments, the workflow may be stopped at any time.

In one or more embodiments, the computer-implemented workflow automation method further comprises performing a reject action with respect to a workflow, the reject action configured to show a rejection visually to the user and to either return the workflow to one of the past workflow steps or not otherwise affect the workflow.

In one or more embodiments, the user interface portion is further configured to enable the user to perform an action with respect to one of the plurality of items from the actionable inbox of the user and wherein upon performance of the action by the user, the respective item is removed from the actionable inbox of the user.

In one or more embodiments, upon every user associated with a step of the workflow performing an action with respect to that step of the workflow, the workflow is configured to proceed to a subsequent step.

In one or more embodiments, a step of the workflow is assigned an attribute indicative of a status of completion of that step.

In one or more embodiments, the attribute is selected from a group comprising: opened, confirmed, in progress, in testing, verified and completed. In one embodiment, the user is able to create any custom attribute list.

In one or more embodiments, the user interface portion is further configured to enable the user to organize the actionable inbox into one or more subfolders.

In one or more embodiments, the workflow automation client is web-based.

In one or more embodiments, the workflow automation client is a mobile application based.

In one or more embodiments, the notification service is configured to provide push notifications or desktop notifications to a workflow automation client of a user, when an action of that user is required with respect to a step of the workflow.

In accordance with another aspect of the embodiments described herein, there is provided a non-transitory computer-readable medium embodying a set of computer-executable instructions, which, when executed in a computerized system comprising a central processing unit, a network interface and a memory, cause the computerized system to perform a method comprising: providing a workflow automation server accessible via a computer network, the workflow automation server comprising: an application engine executing a workflow comprising a plurality of ordered workflow steps; and a user interface portion configured to provide each user with a single actionable inbox comprising a plurality of items, the plurality of items corresponding to the plurality of ordered workflow steps of the workflow. The method further comprising providing a workflow automation client configured to access the workflow automation server via the computer network.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a flexible workflow automation system.

FIG. 2 illustrates an exemplary embodiment of a configuration of the workflow automation server.

FIG. 3 illustrates exemplary data flows between different modules of the flexible workflow automation system.

FIGS. 4(a), 4(b), 4(c), 4(d) and 4(e) illustrate various aspects of the user interface of an embodiment of the flexible workflow automation system described herein.

FIG. 5 illustrates an exemplary embodiment of a computer platform whereupon the various embodiments described herein may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

### An Embodiment of Flexible Workflow Automation System

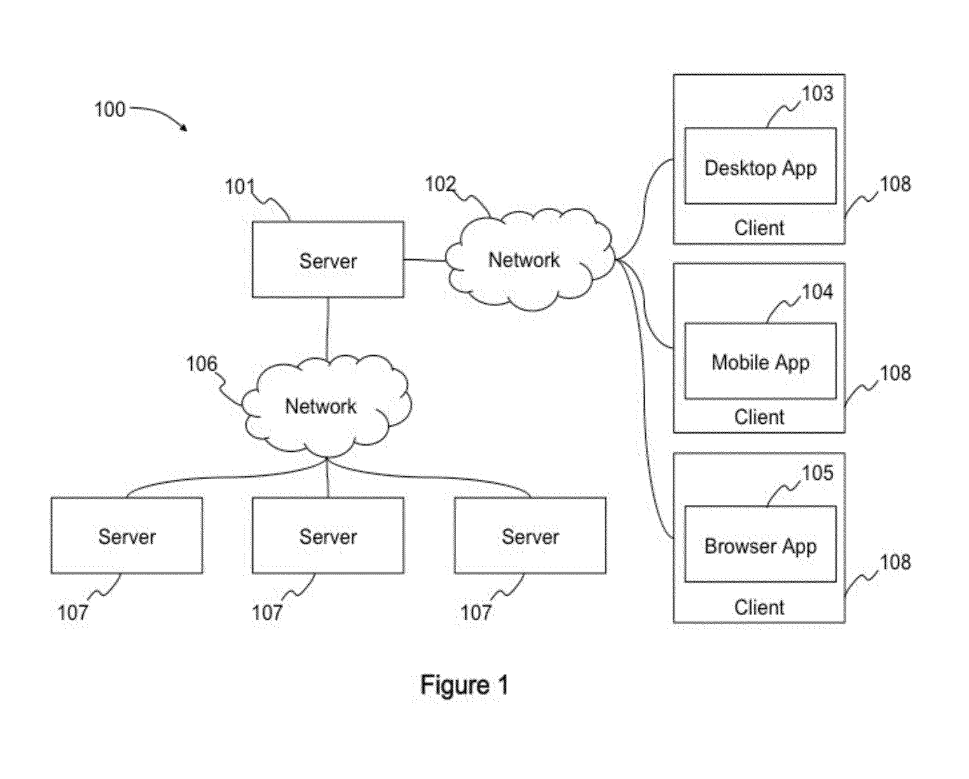

In accordance with one aspect of the embodiments described herein, there are provided flexible workflow automation systems and methods. An exemplary embodiment of the flexible workflow automation system 100 is illustrated in FIG. 1. The flexible workflow automation system 100 incorporates one or more client computer systems or simply clients 108 executing client software applications 103, 104 and 105. The client application 103 is a desktop software application configured to execute under a desktop operating system well known to persons or ordinary skill in the art. The client application 104 is a mobile application executing under a mobile operating system such as Android or iOS well known to persons of ordinary skill in the art. The mobile application 104 may be deployed on a mobile computing platform, such as a smartphone, smartwatch or a tablet computer. Finally, the client application 105 is a browser application, such as a web browser application, which may be deployed in a mobile or desktop environment. Exemplary embodiments of the browser application 105 may include any now known or later developed browser software applications such as Safari, Chrome, Firefox, Opera, Internet Explorer and the like.

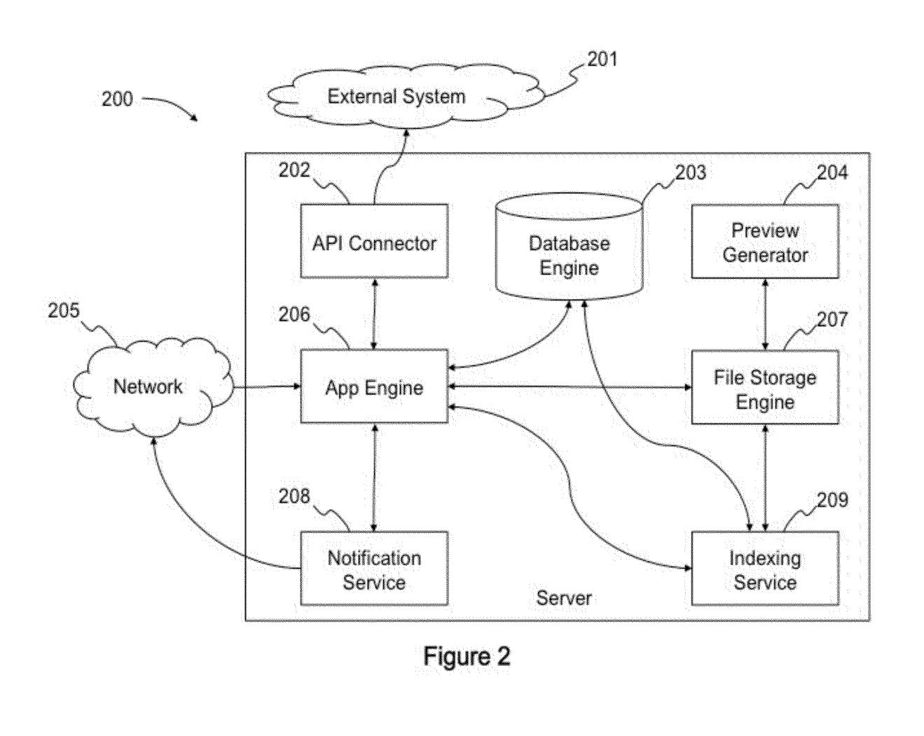

The client software applications 103, 104 and 105 are configured to access a workflow automation server 101 via a network 102. In various embodiments, as shown in FIG. 1, other workflow automation servers 107 accessible via a network 106 may be additionally provided. FIG. 2 illustrates an exemplary embodiment of a configuration 200 of the workflow automation server 101. In various embodiments, the workflow automation server 101 hosts a database engine 203 configured to store and manage various data used in the workflow automation process in one or more database tables. The database engine 203 may be implemented based on any now known or later developed type of database management system, such as a relational database management system, including, without limitation, MySQL, Oracle, SQL Server, DB2, SQL Anywhere, PostgreSQL, SQLite, Firebird, redis, MongoDB, Hadoop and/or MaxDB, which are well-known to persons of skill in the art. In an alternative embodiment, a cloud-based distributed database, such as Amazon Relational Database Service (Amazon RDS), well known to persons of ordinary skill in the art, may also be used in place of the integrated database engine 203.

In various embodiments, the aforesaid database engine 203 of the workflow automation server 101 is configured to store and manage account data for a number of individual users of the flexible workflow automation system 100. In various embodiments, the database engine 203 of the workflow automation server 101 is configured to store end user accounts for a department of an organization, the whole organization, multiple organizations or any combinations of the above.

In various embodiments, the workflow automation server 101 may additionally host a notification service 208 configured to provide various notifications to the users in a desktop environment, mobile environment or by using email communication via a network 205, see FIG. 2. In various embodiments, the workflow automation server 101 may additionally incorporate an indexing service 209 as well as file storage engine 207, which may be implemented using any now known or later developed external file storage engine.

In various embodiments, the workflow automation server 101 may additionally incorporate a preview generator 204 and an application programming interface connector (API) 202 for providing external applications running on an external system 201 with access to the workflow automation applications deployed on the workflow automation server 101. In various embodiments, these workflow automation applications are executed by the application engine 206, shown in FIG. 2. In an alternative embodiment, the workflow automation applications are always running, such as in daemon mode, and ready to receive corresponding requests from an application server.

In various embodiments, the flexible workflow automation system 100 implements a number of workflows. Generally speaking, a workflow is a group of tasks that are similar or that can be done one at a time or contain several steps. Each step of the tasks could have an assigned number, for example starting from 1. In one embodiment, the steps may have their own names.

In various embodiments, for every task in a workflow, it is always known which step is current and it is always known which step is due next by default, upon completion current step. This default behavior of the workflow can be redefined both programmatically and in real-time depending on parameters.

In various embodiments, workflows may be straightforward, such as a simple sequence of consecutive steps, or more complex, which can be diagramed with loops, conditional statements, etc. In various embodiments, an execution of a workflow can be initiated and/or completed by a user event or by an occurrence of a predetermined external event. Additionally or alternatively, the triggering event may be time-based (e.g. the workflow is configured to be triggered at certain point in time). Once the workflow is completed, the current workflow step becomes undefined.

1. In various embodiments, the flexible workflow automation system 100 is configured to provide, for every task in a workflow, a user-fillable form. This user-fillable form may be provided to the user via a network via an HTTP protocol well known to persons of ordinary skill in the art in a form of a fillable HTML form. The aforesaid user-fillable form may incorporate one or multiple information input fields. In one embodiment, the field input values are provided by user when the user initiates a new workflow (or by external system if workflow is triggered by it). In one or more embodiments, the input fields are individual fields, groups of fields, or line item table fields. In one or more embodiments, a value of the input field may be automatically calculated from values of other input fields. In one or more embodiments, the input field may be associated with a pull action such that a value of the field is automatically filled out by a query issued to an external system. In one or more embodiments, the workflow input form is automatically filled in by an external application. In one or more embodiments, the workflow input form may be associated with multiple of printed layouts configured to print the form in a user-readable form. In one or more embodiments, at least one participant may be automatically assigned to one or more of the ordered workflow steps pursuant to one or more rules and depending on values of the workflow input form. In one or more embodiments, these rules may include logical, mathematical, text manipulation or other operations.

In various embodiments, the flexible workflow automation system 100 may incorporate a form input validation module (not shown) providing validation functionality for the information input by the user using the aforesaid user-fillable form. In various embodiments, this form input validation module may perform validation of the information input by the user into the aforesaid form. The validation may be performed using certain predetermined validation criteria, which generally correspond, for example, to the following types of fillable form input fields:

1) limited length text input field permits user to input textual information; 2) lists (e.g. enumerations), which could be hierarchical and which could also be independent or link to other list(s); 3) date/time field allowing user to provide date/time information; 4) numerical field for receiving numerical information from the user, such as a number, amount or counter; 5) accounting field for storing amounts in various currencies; 6) other custom fields with user-defined validation rules; 7) formula field that can be a formula of one or several other fields; 8) group field that does simply visual grouping of elements within a form under common header; 9) file field that can be a list of byte streams and/or links to private or public cloud storages, files can have multiple versions; and 10) table field that can contain any number of fields of types 1-9 above, and may also contain summary values or aggregates for those fields.

In one or more embodiments, the flexible workflow automation system 100 enables the users to change the aforesaid input fields at any time (subject to system access control and permissions restrictions). In various embodiments, some of the aforesaid fields may be assigned certain predetermined default or mandatory settings or values. In one embodiment, these mandatory settings may be global for the entire workflow or may apply only to a certain specific step or steps in the workflow.

In various embodiments, the flexible workflow automation system 100 enables the user to customize the aforesaid fillable form field list at any time, even if the workflow tasks have been already created. In one embodiment, by default, the aforesaid user-fillable form may consist of just one input field, such as a general text input field. In various embodiments, the aforesaid user-fillable forms may be filled out by means of any computing device, including, without limitation, a desktop computer system, a mobile computing device such as a smartphone or a tablet, or a browser executing on any computing platform. In various embodiments, the aforesaid user-fillable forms may be rendered differently for various screen sizes on various devices. In various embodiments, the aforesaid user-fillable forms may be associated with multiple templates for printing.

In various embodiments, the flexible workflow automation system 100 may provide to the user thereof a searching functionality. In various embodiments, the user may be provided with tools to search forms using a search criteria involving one data field or a search criteria involving multiple data fields. In one embodiment, the search function may be implemented using the data query functionality provided by the database engine 203 but also one or more indexing services 209.

In various embodiments, each task in the aforesaid workflow may contain a communication thread. Subject to access-level restrictions, a user is provided with the ability to write comments in the aforesaid communication thread. In addition, the communication thread could be used to log various actions associated with the workflow. In one embodiment, by default, the comments are immutable. In various embodiments, the system can be configured to provided editing and/or removal functionality for the user comments. If the user edits/removes comment, its previous version is saved and can be shown in the task history. In various embodiments, comments may be accompanied by actions such as, but not limited to: 1) Approve; 2) Reject/Deny; 3) Complete; 4) Acknowledge; 5) Unsubscribe as well as any other suitable actions. In various embodiments, the action result is visible by other users. In various embodiments, each task can have multiple file attachments and each file attachment may have multiple file revisions. In various embodiments, files could be in the form of byte stream or links to private or public cloud file storages.

In one or more embodiments, the workflow may be stopped at any time. Also, a reject action may be performed with respect to a workflow, the reject action configured to show a rejection visually to the user and either return the workflow to one of the past workflow steps or not otherwise affect the workflow.

### User Management

In one or more embodiments, the flexible workflow automation system 100 incorporates a user account storage, which may be deployed using the database engine 203 shown in FIG. 2. This storage includes an inbox storage containing inbox records for each user of the flexible workflow automation system 100. For every user of the flexible workflow automation system 100, the user account storage provides an inbox, which may include a list of tasks in a workflow, for which the user is required to perform one or more steps. Every open task can belong to one or many of the aforesaid inboxes. For every task, a user can: 1) Complete a task; 2) Unsubscribe from a task; and 3) Forward a task to someone; 4) Change task parameters; 5) Provide a comment; 6) other action and/or combination of the above. In all cases, the task disappears from the user's inbox and action result is visible by other users in a task log, which may be also maintained by the database engine 203.

In various embodiments, a role is a group of users (called members of the role). If a task is assigned to a role, it appears in the inboxes of every user in that role. When one of the role members fulfills the required step of the assigned task (thus moving task to the next step of the workflow), the completed step disappears from the inboxes of all role members. In an embodiment, a user is capable of setting vacation rules, so that the tasks assigned to this person will be automatically forwarded/reassigned to his/her substitutes. This feature can be configured for certain specific workflows and not the others. In one embodiment, the flexible workflow automation system 100 incorporates functionality for configuring a default behaviour. The aforesaid rules can be applied to the tasks already existing in person's inbox and/or future tasks. In one embodiment, a rule may apply for a specified period of time.

In various embodiments, a user in the flexible workflow automation system 100 can be identified: 1) By name; 2) By name and organization; 3) By email address; 4) By phone number; and 5) By other account (Google, Facebook, Active Directory, LDAP service, SAML-based authentication service, etc). Any user can provide several means of authentication. In various embodiments, a user registered with the flexible workflow automation system 100 may be found in global use directory maintained by the database engine 203. In one embodiment, the user is provided with the ability configure to set privacy settings to hide him or her in the aforesaid global directory.

### Reports

In one or more embodiments, the flexible workflow automation system 100 incorporates one or more registries. A registry may be a list of all forms for a specific workflow. The flexible workflow automation system 100 may incorporate a report generating module (not shown in FIG. 2) for generating various reports related to workflows and providing them to the user. In one embodiment, the aforesaid report generating module may be deployed using the data query capability provided by the database engine 203 and may provide the user with the ability to filter and sort various workflow-related information. The reports generated by the report generation module may be presented to the user in a form of a table including multiple columns. The system may provide the user with the functionality to hide or unhide certain columns in the report.

In one or more embodiments, the reports may be printed or exported to a spreadsheet. In one or more embodiments, for every workflow user can create summary reports over time on the 1) number of tasks; 2) opened/closed tasks and 3) daily/total tasks. Reports may also be generated based on timing. Specifically, min/max/avg first response time, min/max/avg time requested to fulfill certain step, min/max/avg time to criteria may be used for report generation. In one or more embodiments, any report can be averaged daily, weekly, biweekly, monthly, quarterly or yearly. In one or more embodiments, any report can be broken down by enumerated form field value, such as: 1) an illustrating number; 2) illustrating percentage of total or 3) both of the above. Reports can be programmed to be sent automatically on a periodic basis to several of recipients.

In one or more embodiments, any report can have multiple graphical representations including, without limitation, linear, bar, pie-chart, etc. For every workflow user can create analytical reports for a certain moment of time: In one or more embodiments, the number of tasks summarized by enumerated form field values.

### Workflow Administration

In one or more embodiments, for every workflow administrator can set access levels, including, for example:

Who can create tasks in a workflow;

Who can approve in a certain step;

Who can return workflow to a previous step;

Who can close workflow;

Who can read all the tasks in workflow;

Who can configure workflow, define form fields, invite people, define steps, and/or define routing; or

Who can be administrator in this workflow.

In one or more embodiments, the first workflow administrator is the workflow creator.

### Exemplary Data Flows

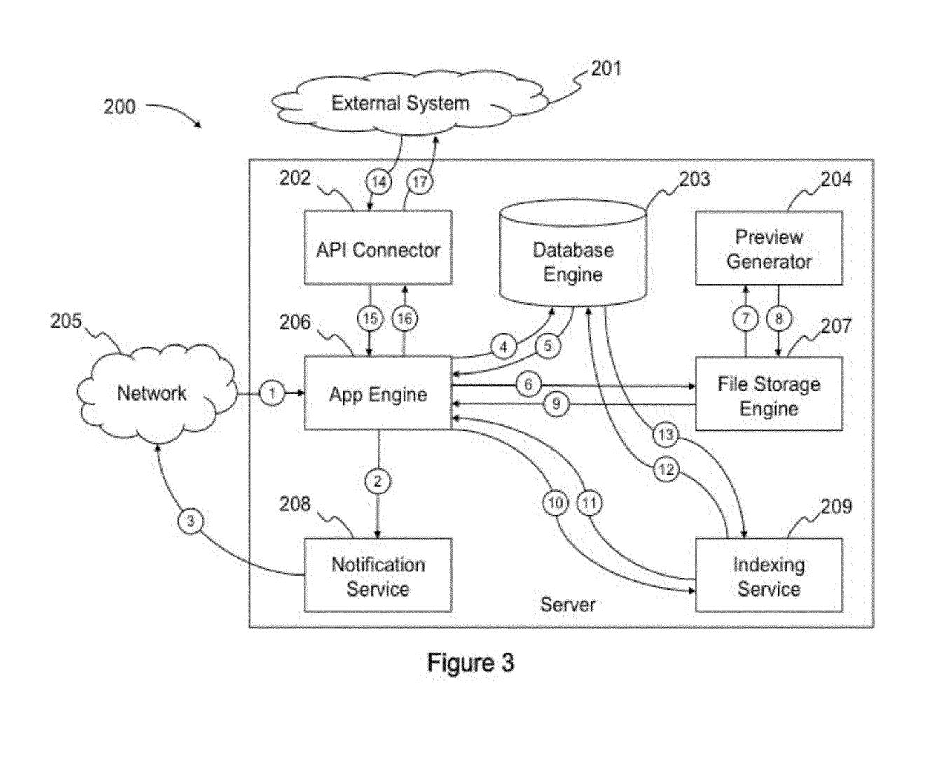

FIG. 3 illustrates exemplary data flows between different modules of the flexible workflow automation system. First, the client sends a request (1), via the network 205, to the server (the application engine 206), requesting information about the tasks and metadata. The application engine 206 processes request in several steps:
a. the application engine 206 checks authentication. It then discovers if it needs to notify other participants of the task and calls the notification service 208 (2). The notification service 208 sends push notifications to mobile or desktop devices and/or email notifications (3).
b. the application engine 206 updates database (4) and retrieves necessary information from database for further processing (5).
c. The application engine 206 saves all files from the incoming request (1) to file storage engine 207 (6). For certain types of files (documents, pictures, video) a request to generate preview is launched (7). The preview generator module 204 processes the request and produces a file or a list of files that contain visual representation of original file. Those preview files are then being put to the file storage engine 207 (8). If needed, previews are retrieved from the file storage engine 207 sent back to the application engine 206 (9).
d. If required, application engine 206 queries the indexing service 209 for text data (10). In response, the indexing service returns back the results (11).
e. In the background, the indexing service 209 permanently scans database for recent changes (12) and updates its indices (13).
   In various embodiments, an external system, which can be a web service, desktop or mobile app, or a background service with no user interface, can issue calls to flexible workflow automation system (14). Those calls arrive through the API connector 202, which authenticates them and handles to application engine 206 (15) for further processing. The application engine 206 does its usual routine and returns back results to the API connector 202 (16), which in turn sends them back to original call initiator (17).

### Exemplary User Interface

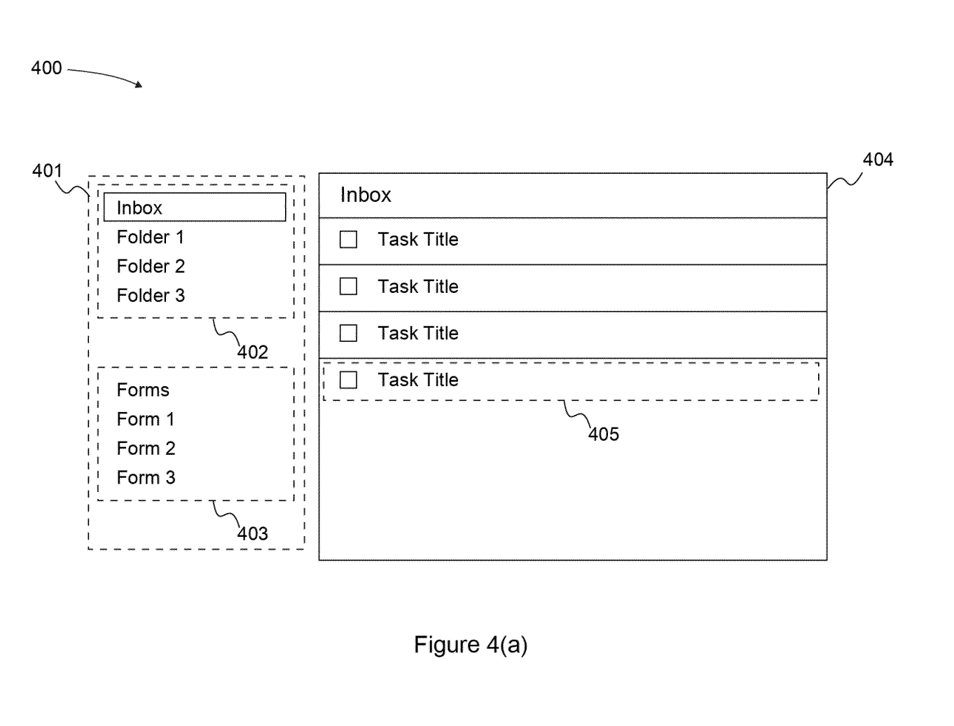

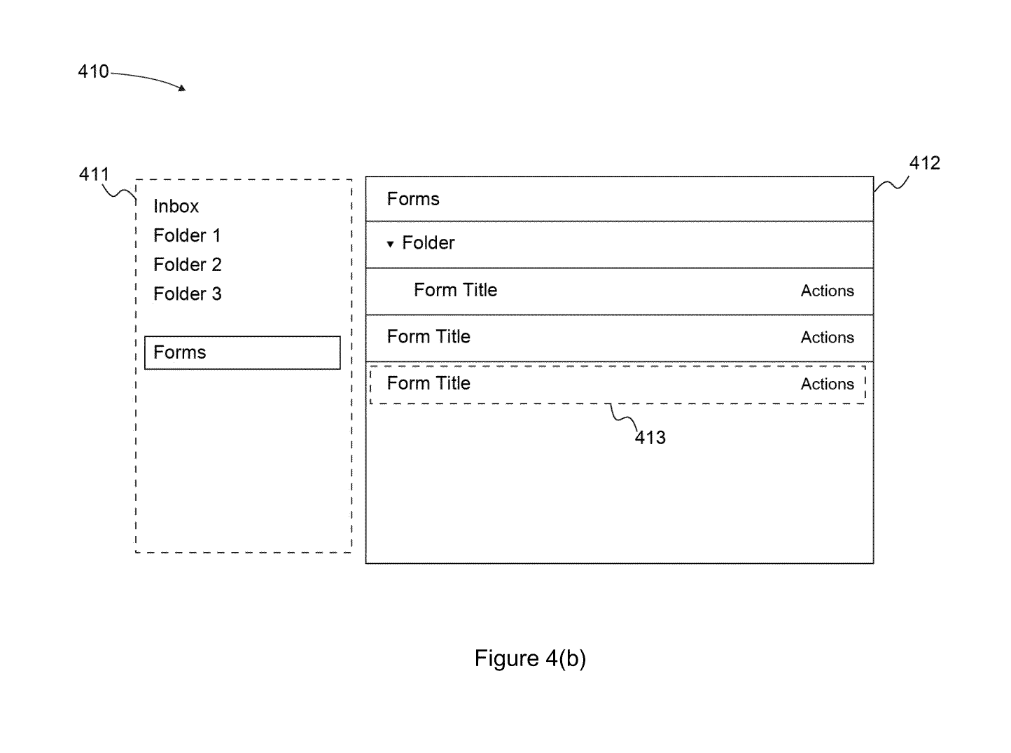

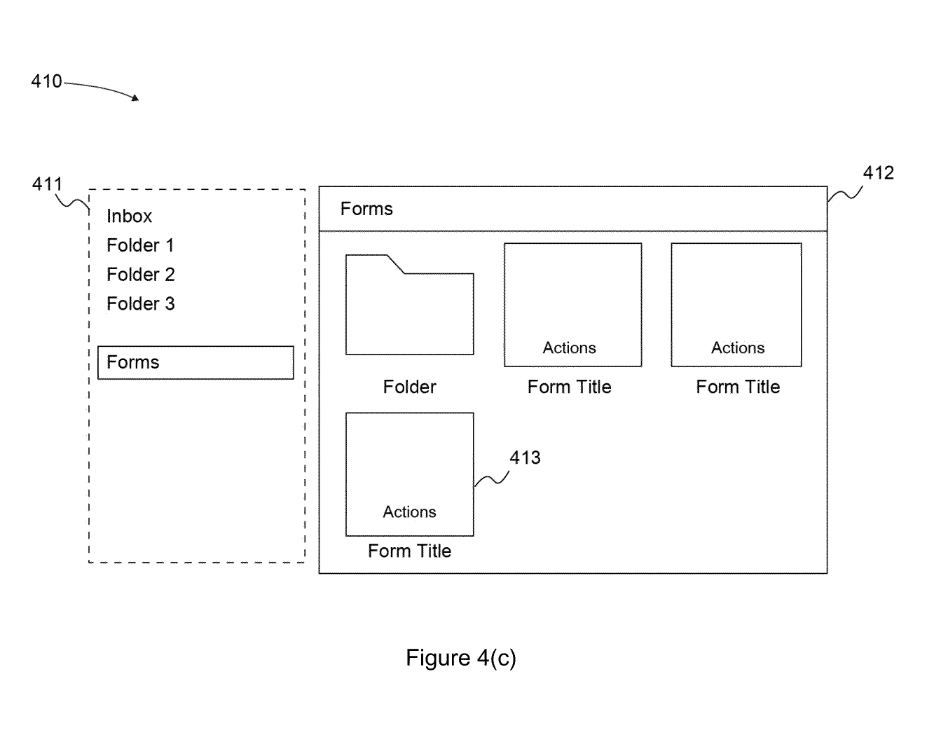

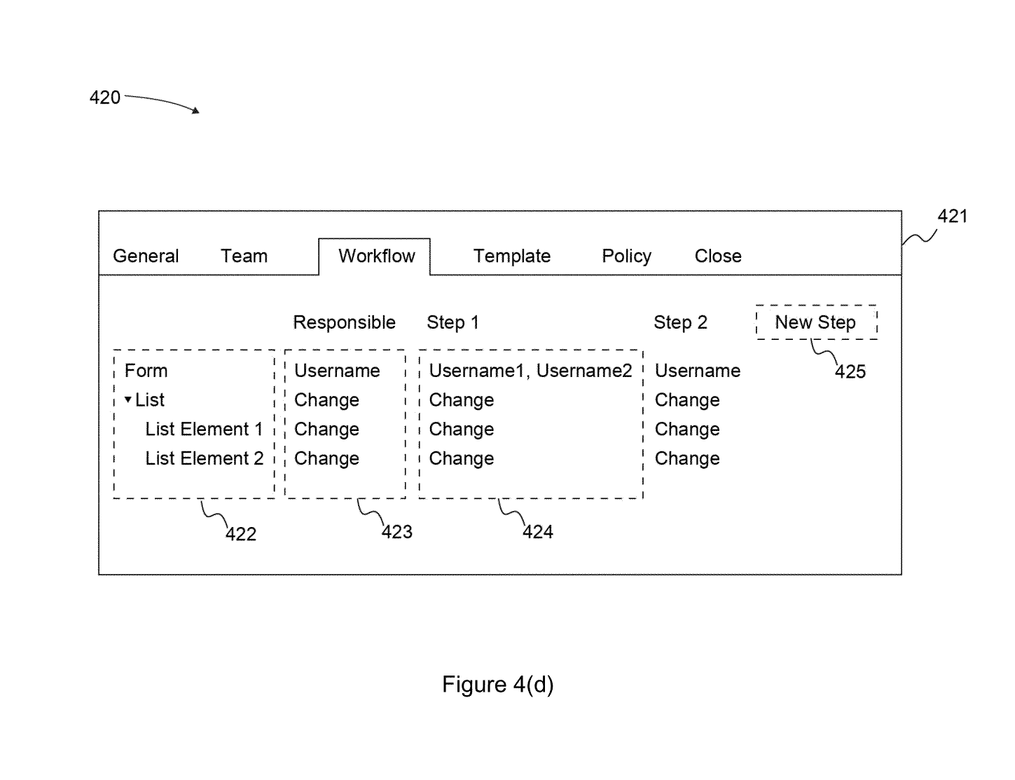

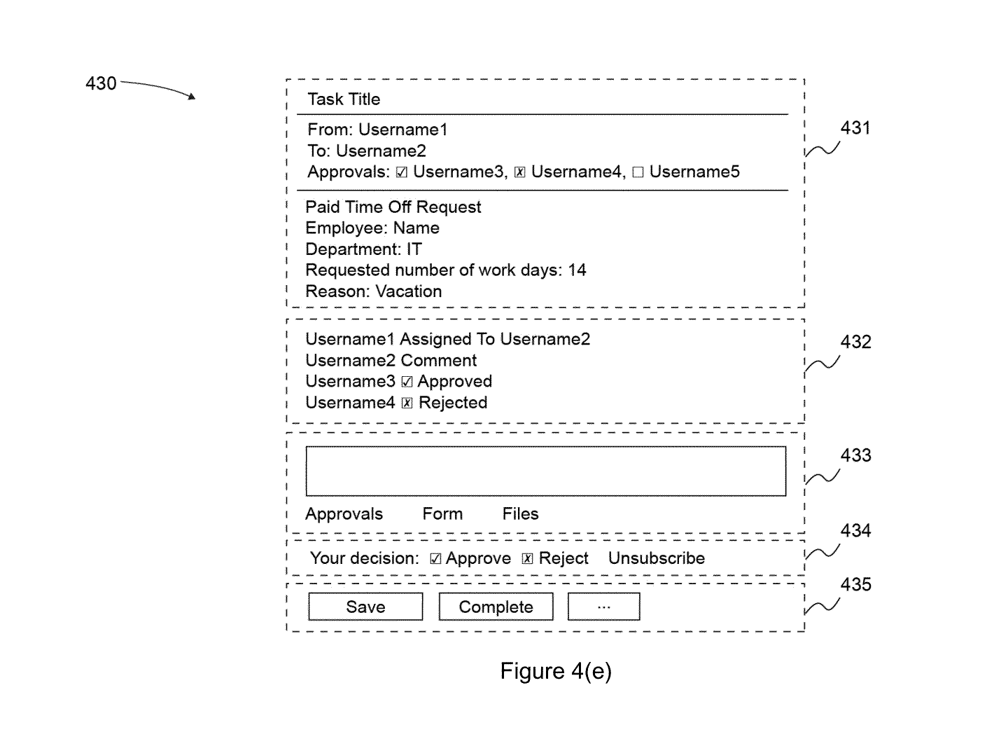

FIGS. 4(a), 4(b), 4(c), 4(d), and 4(e) illustrate various aspects of the user interface of an embodiment of the flexible workflow automation system described herein. Specifically, FIG. 4(a) illustrates an exemplary user interface 400 for browsing existing tasks (workflows) and creating new tasks. Specifically, the user interface 400 incorporates a menu widget 401, which may be implemented in a form of an itemized list.

In various embodiments, the aforesaid menu widget 401 further incorporates a folder list portion 402, configured to display a list of folders containing one or more tasks.

In various embodiments, the menu widget 401 also incorporates a forms list portion 403, configured to display a link to forms page and a list of shortcuts to specific forms. Upon detection of the activation of this widget by the user, the flexible workflow automation system is configured to present to the user a user interface for a new form creation.

In various embodiments, the user interface 400 further includes an active page view portion 404 containing a list of tasks 405 within the selected folder. Each task listed in the folder view portion 404 could be selected by the user for more detailed viewing.

Similarly, FIGS. 4(b) and 4(c) illustrate an exemplary user interface 410 for browsing existing forms in a specific business process and creating new ones. Specifically, the user interface 410 incorporates a new form creation widget 411, which may be implemented in a form of a button. Upon detection of the activation of this widget by the user, the flexible workflow automation system is configured to present to the user an interface to create a form adhering to a form template specifically designed for this business process.

In various embodiments, the user interface 410 shown in FIGS. 4(b) and 4(c) further incorporates a list 412 of forms in a specific business process. For each form 413 in the list the form title is shown, as well as the list of actions available for this form. Each form 413 listed may be selected by the user for new task creation by filling out the corresponding form fields.

In various embodiments, the aforesaid list 412 of forms may be organized in a form of a column (FIG. 4(b)), in a grid (FIG. 4(c)), in a calendar, or in any other appropriate manner. The list 412 also provides an interface for filtering, reordering, printing, and exporting of its contents.

FIG. 4(d) illustrates an exemplary user interface 420 for creating a new workflow template. The panel 421 contains the list of tabs, each pertaining to one aspect of a form template configuration. In particular, the Workflow tab helps to configure a form workflow template.

In various embodiments, the body of the aforesaid Workflow tab consists of a table containing a row for the form itself, and also a row for each item in each list included in the form (enumerated in the column 422). The column 423 makes it possible to specify a particular responsible person for each row.

In various embodiments, the body of the Workflow tab further incorporates one or more columns 424 (one for each workflow step), each aimed to edit the list of persons whose input is required before the workflow may proceed further, to later steps. Similarly to how the column 423 operates, the columns 424 allow setting different lists of persons for different rows. In other embodiment, user can specify roles (i.e. aliases that may contain a number of people) instead of persons directly.

In one or more embodiments, the result of the setup made in the aforesaid columns 423 and 424 is the following. Consider a particular form filled out in accordance with this workflow template. Depending on which items are selected in List fields, this form goes through a custom workflow designed specifically for this particular situation. Namely, the resulting workflow is the combination of workflows specified via columns 423 and 424 for all items selected in all List fields plus the workflow specified for the form itself.

In one or more embodiments, the list of workflow steps is not fixed, and new workflow steps may be added via the New Step widget 425, which also allows setting custom names for workflow steps.

FIG. 4(e) illustrates an exemplary user interface 430 for notifying the user of a workflow step required to be performed by the said user.

Specifically, the interface 430 includes the task (form) summary area 431, which contains the task title, the task author, as well as the person currently responsible for this task. The task summary area 431 also lists all approvals requested from persons and workflow roles for this particular task in all workflow steps, including granted and pending approvals, and rejections. The area 431 ends with the list of all form fields and their current values.

In one or more embodiments, the interface 430 continues with the task change log 432, enumerating literally all changes made to this task (form) since its creation, so that it is impossible to change a task in any way without the complete description of the changes appearing in the task change log 432. The possible list of task changes includes, but is not limited to: reassigning a task to another person, granting or rejecting an approval, leaving a text comment, editing form fields, attaching supplementary files, scheduling task execution for later date, marking task as complete, etc

In one or more embodiments, the exemplary interface 430 further incorporates the task editing area 433, which provides the user interface to change the task. The possible changes are described in more detail in the previous paragraph. Specifically, the task editing area 433 in the FIG. 4(e) shows the text comment area, which can be implemented in a form of multi-line text, as well as the Approvals tab, which allows the user to customize the workflow, add and remove requested approvals and/or add and remove approval steps; note also the Form tab, which provides the user interface to change the values of the form fields, and Files tab, which makes it possible to attach to the task new files or new versions of files already attached.

In one or more embodiments, the user approval panel 434 allows the user to quickly grant the approval, reject the approval request, or remove his/her approval from the workflow.

In one or more embodiments, the interface 430 ends with the decision panel, which the user utilizes to save the changes made to the task, mark the task as complete or reopen it again, or other appropriate actions.

### Exemplary Computer Platform

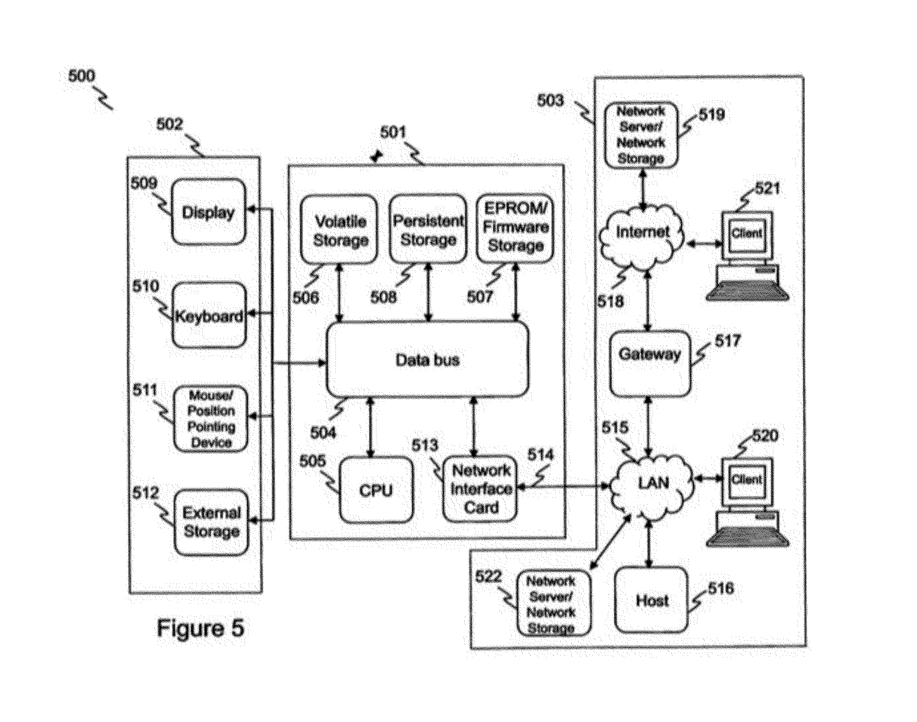

FIG. 5 is a block diagram that illustrates an embodiment of a computer system 500 upon which various embodiments of the inventive concepts described herein may be implemented. The system 500 includes a computer platform 501, peripheral devices 502 and network resources 503.

The computer platform 501 may include a data bus 505 or other communication mechanism for communicating information across and among various parts of the computer platform 501, and a processor 505 coupled with bus 501 for processing information and performing other computational and control tasks. Computer platform 501 also includes a volatile storage 506, such as a random access memory (RAM) or other dynamic storage device, coupled to bus 505 for storing various information as well as instructions to be executed by processor 505. The volatile storage 506 also may be used for storing temporary variables or other intermediate information during execution of instructions by processor 505. Computer platform 501 may further include a read only memory (ROM or EPROM) 507 or other static storage device coupled to bus 505 for storing static information and instructions for processor 505, such as basic input-output system (BIOS), as well as various system configuration parameters. A persistent storage device 508, such as a magnetic disk, optical disk, or solid-state flash memory device is provided and coupled to bus 501 for storing information and instructions.

Computer platform 501 may be coupled via bus 505 to a display 509, such as a cathode ray tube (CRT), plasma display, or a liquid crystal display (LCD), for displaying information to a system administrator or user of the computer platform 501. An input device 510, including alphanumeric and other keys, is coupled to bus 501 for communicating information and command selections to processor 505. Another type of user input device is cursor control device 511, such as a mouse, a trackball, or cursor direction keys for communicating direction information and command selections to processor 505 and for controlling cursor movement on display 509. This input device typically has two degrees of freedom in two axes, a first axis (e.g., x) and a second axis (e.g., y), that allows the device to specify positions in a plane.

An external storage device 512 may be coupled to the computer platform 501 via bus 505 to provide an extra or removable storage capacity for the computer platform 501. In an embodiment of the computer system 500, the external removable storage device 512 may be used to facilitate exchange of data with other computer systems.

The invention is related to the use of computer system 500 for implementing the techniques described herein. In an embodiment, the inventive system may reside on a machine such as computer platform 501. According to one embodiment of the invention, the techniques described herein are performed by computer system 500 in response to processor 505 executing one or more sequences of one or more instructions contained in the volatile memory 506. Such instructions may be read into volatile memory 506 from another computer-readable medium, such as persistent storage device 508. Execution of the sequences of instructions contained in the volatile memory 506 causes processor 505 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 505 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 508. Volatile media includes dynamic memory, such as volatile storage 506.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 505 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 505. The bus 505 carries the data to the volatile storage 506, from which processor 505 retrieves and executes the instructions. The instructions received by the volatile memory 506 may optionally be stored on persistent storage device 508 either before or after execution by processor 505. The instructions may also be downloaded into the computer platform 501 via Internet using a variety of network data communication protocols well known in the art.

The computer platform 501 also includes a communication interface, such as network interface card 513 coupled to the data bus 505. Communication interface 513 provides a two-way data communication coupling to a network link 515 that is coupled to a local network 515. For example, communication interface 513 may be an integrated services digital network (ISDN) card or a modem to provide a data communication connection to a corresponding type of telephone line. As another example, communication interface 513 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 513 sends and receives electrical, electromagnetic or optical signals that carry digital data streams representing various types of information.

Network link 513 typically provides data communication through one or more networks to other network resources. For example, network link 515 may provide a connection through local network 515 to a host computer 516, or a network storage/server 517. Additionally or alternatively, the network link 513 may connect through gateway/firewall 517 to the wide-area or global network 518, such as an Internet. Thus, the computer platform 501 can access network resources located anywhere on the Internet 518, such as a remote network storage/server 519. On the other hand, the computer platform 501 may also be accessed by clients located anywhere on the local area network 515 and/or the Internet 518. The network clients 520 and 521 may themselves be implemented based on the computer platform similar to the platform 501.

Local network 515 and the Internet 518 both use electrical, electromagnetic or optical signals that carry digital data streams. The signals through the various networks and the signals on network link 515 and through communication interface 513, which carry the digital data to and from computer platform 501, are exemplary forms of carrier waves transporting the information.

Computer platform 501 can send messages and receive data, including program code, through the variety of network(s) including Internet 518 and LAN 515, network link 515 and communication interface 513. In the Internet example, when the system 501 acts as a network server, it might transmit a requested code or data for an application program running on client(s) 520 and/or 521 through Internet 518, gateway/firewall 517, local area network 515 and communication interface 513. Similarly, it may receive code from other network resources.

The received code may be executed by processor 505 as it is received, and/or stored in persistent or volatile storage devices 508 and 506, respectively, or other non-volatile storage for later execution.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the flexible workflow automation system and method. It is intended that the specification and examples be considered as exemplary only, with a true scope and spirit of the invention being indicated by the following claims.

What is claimed is:

1. A computerized workflow automation system comprising:
a. at least one workflow automation server accessible via a computer network, the workflow automation server comprising:
i. an application engine executing one or more workflows comprising a plurality of ordered workflow steps; and
ii. a user interface portion configured to provide each user with a single actionable inbox comprising a plurality of items, the plurality of items corresponding to the plurality of ordered workflow steps of the workflow; and
b. a workflow automation client configured to access the workflow automation server via the computer network.

2. The computerized workflow automation system of claim 1, wherein the user interface portion is further configured to provide a workflow input form comprising a plurality of input fields corresponding to the plurality of ordered workflow steps of a workflow.

3. The computerized workflow automation system of claim 2, wherein the plurality of input fields are individual fields, groups of fields, or line item table fields.

4. The computerized workflow automation system of claim 2, wherein a field of the plurality of input fields is automatically calculated from values of other fields of the plurality of input fields.

5. The computerized workflow automation system of claim 2, wherein a field of the plurality of input fields is associated with a pull action such that a value of the field is automatically filled out by a query issued to an external system.

6. The computerized workflow automation system of claim 2, wherein the workflow input form is automatically filled in by an external application.

7. The computerized workflow automation system of claim 2, wherein the workflow input form is associated with a plurality of printed layouts.

8. The computerized workflow automation system of claim 1, wherein at least one participant is automatically assigned to one or more of the plurality of ordered workflow steps pursuant to one or more rules and depending on values of the workflow input form.

9. The computerized workflow automation system of claim 8, wherein the rules comprise logical, mathematical, text manipulation or other operations.

10. The computerized workflow automation system of claim 1, further comprising a notification service configured to execute a communication thread to receive and handle comments from users and log actions associated with the workflow.

11. The computerized workflow automation system of claim 1, wherein each step of the workflow is associated with one user or a plurality of users.

12. The computerized workflow automation system of claim 1, wherein some steps of the workflow are associated with one or more user roles.

13. The computerized workflow automation system of claim 1, wherein a step of the workflow is associated with at least one user or a plurality of users and at least one user role or a plurality of user roles.

14. The computerized workflow automation system of claim 1, wherein the user interface portion is further configured to enable the user to approve one of the plurality of items from the actionable inbox of the user and wherein upon the approval by the user, the respective item is removed from the actionable inbox of the user.

15. The computerized workflow automation system of claim 14, wherein the user interface portion is further configured to enable the user to change one or more values of the workflow input form, causing to automatic recalculation of participants of one or more of the plurality of ordered workflow steps.

16. The computerized workflow automation system of claim 15, wherein the automatic recalculation is performed with respect to future workflow steps.

17. The computerized workflow automation system of claim 15, wherein the automatic recalculation is performed with respect to past workflow steps.

18. The computerized workflow automation system of claim 1, wherein the user interface portion is further configured to enable the user to add a comment to the workflow.

19. The computerized workflow automation system of claim 1, wherein the user interface portion is further configured to enable the user to perform an action with respect to one of the plurality of items from the actionable inbox of the user and wherein upon performance of the action by the user, the respective item is removed from the actionable inbox of the user.

20. The computerized workflow automation system of claim 19, wherein the user action comprises an action performed in an external system or causes a message to be sent.

21. The computerized workflow automation system of claim 1, wherein upon every user or user role associated with a step of the workflow performing an action with respect to that step of the workflow, the workflow is configured to proceed to a subsequent step.

22. The computerized workflow automation system of claim 1, wherein a step of the workflow is assigned an attribute indicative of a status of completion of that step.

23. The computerized workflow automation system of claim 22, wherein the attribute is selected from a group comprising: opened, confirmed, in progress, in testing, verified and completed.

24. The computerized workflow automation system of claim 1, wherein the user interface portion is further configured to enable the user to organize the actionable inbox into one or more subfolders.

25. The computerized workflow automation system of claim 1, wherein the workflow automation client is web-based.

26. The computerized workflow automation system of claim 1, wherein the workflow automation client is a mobile application based.

27. The computerized workflow automation system of claim 1, wherein the workflow automation client is a desktop application based.

28. The computerized workflow automation system of claim 1, wherein the workflow automation client is a smartwatch application based.

29. The computerized workflow automation system of claim 1, wherein the notification service is configured to provide push notifications or desktop notifications to a workflow automation client of a user, when an action of that user is required with respect to a step of the workflow.

30. The computerized workflow automation system of claim 1, comprising at least two workflow automation servers configured as a server cluster.

31. The computerized workflow automation system of claim 1, wherein the application engine executes a plurality of different workflows, each of the plurality of different workflows being associated with at least one administrator who has been designated to configure the each workflow.

32. The computerized workflow automation system of claim 31, wherein different workflows are assigned to different administrators.

33. The computerized workflow automation system of claim 1, further comprising a notification service configured to generate email notification to indicate that an action is required from a user associated with the workflow.

34. The computerized workflow automation system of claim 1, further comprising a notification service configured to generate email notification to indicate that a plurality of actions is required from a user associated with the workflow.

35. The computerized workflow automation system of claim 1, further comprising a reporting engine configured to provide summary reports comprising a total number of tasks, daily opened/closed steps, time to complete the workflow, or predetermined steps of the workflow, service level or other reports, breakdown of quantitative metrics by user, workflow step or a predetermined form field.

36. The computerized workflow automation system of claim 35, wherein the time to complete the workflow is based on working hours schedule.

37. The computerized workflow automation system of claim 35, wherein the reports are filtered based on predetermined parameters.

38. The computerized workflow automation system of claim 35, wherein the reports are printed.

39. The computerized workflow automation system of claim 35, wherein the reports are exported to an external document or generated automatically and electronically transmitted to one or more recipients.

40. A computer-implemented workflow automation method comprising:
a. providing a workflow automation server accessible via a computer network, the workflow automation server comprising:
i. an application engine executing one or more workflows comprising a plurality of ordered workflow steps; and
ii. a user interface portion configured to provide each user with a single actionable inbox comprising a plurality of items, the plurality of items corresponding to the plurality of ordered workflow steps of the workflow; and
b. providing a workflow automation client configured to access the workflow automation server via the computer network.

41. The computer-implemented workflow automation method of claim 40, wherein the user interface portion is further configured to provide a workflow input form comprising a plurality of input fields corresponding to the plurality of ordered workflow steps of a workflow.

42. The computer-implemented workflow automation method of claim 40, further comprising providing a notification service configured to execute a communication thread to receive and handle comments from users and log actions associated with the workflow.

43. The computer-implemented workflow automation method of claim 40, wherein each step of the workflow is associated with one user or a plurality of users.

44. The computer-implemented workflow automation method of claim 40, wherein some steps of the workflow are associated with one user, a plurality of users, one user role, or a plurality of user roles, or a combination of plurality of users and plurality of user roles.

45. The computer-implemented workflow automation method of claim 40, wherein the user interface portion is further configured to enable the user to approve one of the plurality of items from the actionable inbox of the user and wherein upon the approval by the user, the respective item is removed from the actionable inbox of the user.

46. The computer-implemented workflow automation method of claim 40, wherein the workflow may be stopped at any time.

47. The computer-implemented workflow automation method of claim 40, further comprising performing a reject action with respect to a workflow, the reject action configured to show a rejection visually to the user and to either return the workflow to one of the past workflow steps or not otherwise affect the workflow.

48. The computer-implemented workflow automation method of claim 40, wherein the user interface portion is further configured to enable the user to perform an action with respect to one of the plurality of items from the actionable inbox of the user and wherein upon performance of the action by the user, the respective item is removed from the actionable inbox of the user.

49. The computer-implemented workflow automation method of claim 40, wherein upon every user associated with a step of the workflow performing an action with respect to that step of the workflow, the workflow is configured to proceed to a subsequent step.

50. The computer-implemented workflow automation method of claim 40, wherein a step of the workflow is assigned an attribute indicative of a status of completion of that step.

51. The computer-implemented workflow automation method of claim 50, wherein the attribute is selected from a group comprising: opened, confirmed, in progress, in testing, verified, completed and one or more custom attributes specified by the administrator.

52. The computer-implemented workflow automation method of claim 40, wherein the user interface portion is further configured to enable the user to organize the actionable inbox into one or more subfolders.

53. The computer-implemented workflow automation method of claim 40, wherein the workflow automation client is web-based.

54. The computer-implemented workflow automation method of claim 40, wherein the workflow automation client is a mobile application based.

55. The computer-implemented workflow automation method of claim 40, wherein the notification service is configured to provide push notifications or desktop notifications to a workflow automation client of a user, when an action of that user is required with respect to a step of the workflow.

56. A non-transitory computer-readable medium embodying a set of computer-executable instructions, which, when executed in a computerized system comprising a central processing unit, a network interface and a memory, cause the computerized system to perform a method comprising:
a. providing a workflow automation server accessible via a computer network, the workflow automation server comprising:
i. an application engine executing a workflow comprising a plurality of ordered workflow steps; and
ii. a user interface portion configured to provide each user with a single actionable inbox comprising a plurality of items, the plurality of items corresponding to the plurality of ordered workflow steps of the workflow; and
b. providing a workflow automation client configured to access the workflow automation server via the computer network.
